(19) United States
(12) Patent Application Publication
(10) Pub. No.: US 2023/0228595 A1
(43) Pub. Date: Jul. 20, 2023

(54) POSITION DETECTION DEVICE

(71) Applicant: Murata Manufacturing Co., Ltd., Nagaokakyo-shi (JP)

(72) Inventor: Daisuke NAKAMURA, Nagaokakyo-shi (JP)

(21) Appl. No.: 18/118,763

(22) Filed: Mar. 8, 2023

Related U.S. Application Data
(63) Continuation of application No. PCT/JP2021/029706, filed on Aug. 12, 2021.

(30) Foreign Application Priority Data
Sep. 30, 2020 (JP) 2020-165047

(51) Int. Cl. G01D 5/16; G03B 13/36; G03B 5/02

(52) U.S. Cl. CPC G01D 5/16; G03B 5/02; G03B 13/36; G03B 2205/0007; G03B 2205/0061

(57) ABSTRACT

A position detection device detects a position of a lens holder in an X-axis direction based on a change in an output value of a first magnetic sensor, a position of the lens holder in a Y-axis direction based on a change in an output value of a second magnetic sensor, and a position of the lens holder in a Z-axis direction based on the changes in the output values of the first magnetic sensor and the second magnetic sensor.

### CROSS REFERENCE TO RELATED APPLICATIONS

This application claims the benefit of priority to Japanese Patent Application No. 2020-165047 filed on Sep. 30, 2020 and is a Continuation Application of PCT Application No. PCT/JP2021/029706 filed on Aug. 12, 2021. The entire contents of each application are hereby incorporated herein by reference.

### BACKGROUND OF THE INVENTION

### 1. Field of the Invention

The present invention relates to a position detection device.

### 2. Description of the Related Art

Japanese Patent Laid-Open No. 2015-194660 is a prior art document disclosing a configuration of a camera module. The camera module described in Japanese Patent Laid-Open No. 2015-194660 includes a lens, a lens holder that holds the lens, an autofocus magnet attached to the lens holder, a camera shake correction magnet, an autofocus magnetic sensor, and a camera shake correction magnetic sensor. The camera shake correction magnetic sensor includes an X-axis camera shake correction magnetic sensor and a Y-axis camera shake correction magnetic sensor.

The camera module described in Japanese Patent Laid-Open No. 2015-194660 includes the autofocus magnetic sensor, the X-axis camera shake correction magnetic sensor, and the Y-axis camera shake correction magnetic sensor, and therefore requires three or more magnetic sensors.

### SUMMARY OF THE INVENTION

Preferred embodiments of the present invention provide position detection devices that are each able to detect positions in the X-axis direction, the Y-axis direction, and the Z-axis direction based on output values of two magnetic sensors.

A position detection device according to a preferred embodiment of the present invention includes a lens holder, a first magnet, a second magnet, a first magnetic sensor, and a second magnetic sensor. The lens holder holds a lens having an optical axis direction and is movable in the optical axis direction and an in-plane direction orthogonal or substantially orthogonal to the optical axis direction. The first magnet is attached to the lens holder to generate a first magnetic field. The second magnet is attached to the lens holder to generate a second magnetic field. The first magnetic sensor is fixed to detect the first magnetic field applied from the first magnet relatively moved when the lens holder is moved. The second magnetic sensor is fixed to detect the second magnetic field applied from the second magnet relatively moved when the lens holder is moved. A polarizing direction of the first magnet is along a first direction orthogonal or substantially orthogonal to the optical axis direction. A polarizing direction of the second magnet is along a second direction orthogonal or substantially orthogonal to each of the optical axis direction and the first direction. A magnetization sensing surface of the first magnetic sensor extends along each of a third direction parallel or substantially parallel to the optical axis direction and the first direction. A magnetization sensing surface of the second magnetic sensor extends along each of the third direction and the second direction. The position detection device is operable to detect a position of the lens holder in the first direction based on a change in an output value of the first magnetic sensor. The position detection device is operable to detect a position of the lens holder in the second direction based on a change in an output value of the second magnetic sensor. The position detection device is operable to detect a position of the lens holder in the third direction based on the changes in the output values of the first magnetic sensor and the second magnetic sensor.

According to preferred embodiments of the present invention, positions in an X-axis direction defined as a first direction, a Y-axis direction defined as a second direction, and a Z-axis direction defined as a third direction can be detected based on output values of two magnetic sensors.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a configuration of a lens driving device including a position detection device according to a preferred embodiment of the present invention.

FIG. 2 is a side view of the lens driving device of FIG. 1 when viewed in a direction of arrow II.

FIG. 3 is a plan view showing a phase of a first magnetic field with respect to a reference angle, the first magnetic field acting on a magnetization sensing surface of a first magnetic sensor included in a position detection device according to a preferred embodiment of the present invention.

FIG. 4 is a plan view showing a phase of the first magnetic field with respect to a reference angle, the first magnetic field acting on a magnetization sensing surface of a second magnetic sensor included in a position detection device according to a preferred embodiment of the present invention.

FIG. 5 is a graph showing a relationship between a phase of a magnetic field applied to a magnetic sensor with respect to a reference angle and an output of a magnetic sensor in a position detection device according to a preferred embodiment of the present invention.

FIG. 6 is a diagram showing a configuration of each of the first magnetic sensor and the second magnetic sensor included in a position detection device according to a preferred embodiment of the present invention.

FIG. 7 is a diagram showing a circuit configuration of each of the first magnetic sensor and the second magnetic sensor included in a position detection device according to a preferred embodiment of the present invention.

FIG. 8 is an enlarged perspective view of a portion VIII in FIG. 6.

FIG. 9 is a cross sectional view when viewed in a direction of arrow of a line IX-IX in FIG. 8.

FIG. 10 is a block diagram showing a configuration of a connection between a position detection device according to a preferred embodiment of the present invention and a driving mechanism.

FIG. 11 is a graph showing a transition in output value of a first magnetic sensor due to displacement of a lens holder in an X-axis direction in a position detection device according to a preferred embodiment of the present invention.

FIG. 12 is a graph showing a transition in output value of s second magnetic sensor due to displacement of a lens holder in an X-axis direction in a position detection device according to a preferred embodiment of the present invention.

FIG. 13 is a graph showing a transition in output value of a first magnetic sensor due to displacement of a lens holder in a Y-axis direction in a position detection device according to a preferred embodiment of the present invention.

FIG. 14 is a graph showing a transition in output value of a second magnetic sensor due to displacement of a lens holder in a Y-axis direction in a position detection device according to a preferred embodiment of the present invention.

FIG. 15 is a graph showing a transition in output value of a first magnetic sensor due to displacement of a lens holder in a Z-axis direction in a position detection device according to a preferred embodiment of the present invention.

FIG. 16 is a graph showing a transition in output value of a second magnetic sensor due to displacement of a lens holder in a Z-axis direction in a position detection device according to a preferred embodiment of the present invention.

FIG. 17 is a side view showing a manner of mounting of each of a first magnetic sensor and a second magnetic sensor in a position detection device according to a modification of a preferred embodiment of the present invention.

### DETAILED DESCRIPTION OF THE PREFERRED EMBODIMENTS

Hereinafter, position detection devices according to preferred embodiments of the present invention will be described with reference to drawings. In the description of preferred embodiments of the present invention, the same or corresponding portions in the drawings are denoted by the same reference characters and will not be described repeatedly.

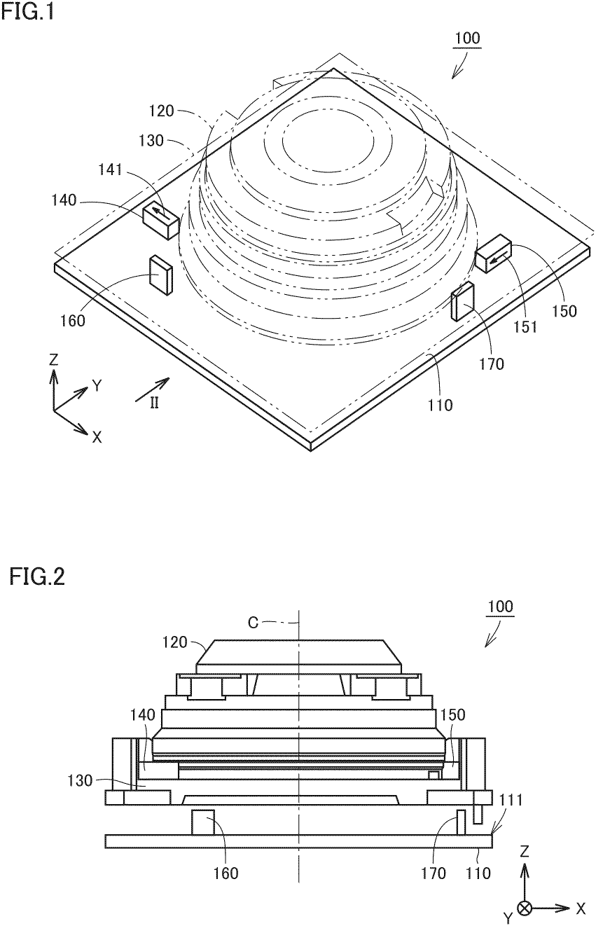

FIG. 1 is a perspective view showing a configuration of a lens driving device including a position detection device according to a preferred embodiment of the present invention. FIG. 2 is a side view of the lens driving device of FIG. 1 when viewed in a direction of arrow II. In each of FIGS. 1 and 2, an X-axis direction is shown to represent a first direction orthogonal or substantially orthogonal to an optical axis direction to be described later, a Y-axis direction is shown to represent a second direction orthogonal or substantially orthogonal to each of the optical axis direction and the X-axis direction, and a Z-axis direction is shown to represent a third direction parallel or substantially parallel to the optical axis direction of the lens.

As shown in FIGS. 1 and 2, a lens driving device 100 including the position detection device according to the present preferred embodiment includes a substrate 110, a lens holder 120, a first magnet 140, a second magnet 150, a first magnetic sensor 160, and a second magnetic sensor 170. The position detection device according to the present preferred embodiment includes lens holder 120, first magnet 140, second magnet 150, first magnetic sensor 160, and second magnetic sensor 170.

Lens holder 120 holds a lens (not shown). The lens has the optical axis direction. Lens holder 120 has a cylindrical or substantially cylindrical shape centered on an optical axis C of the lens shown in FIG. 2. Lens holder 120 is mounted on substrate 110 with a driving mechanism 130 being interposed therebetween. Driving mechanism 130 includes a wire (not shown) connected to substrate 110.

In the present preferred embodiment, driving mechanism 130 is a driving mechanism that provides an autofocus function of moving lens holder 120 in the optical axis direction of the lens, which is a direction parallel or substantially parallel to optical axis C. Moreover, driving mechanism 130 is a driving mechanism that provides a camera shake correction function of moving lens holder 120 in an in-plane direction orthogonal or substantially orthogonal to the optical axis direction.

Driving mechanism 130 includes a piezoelectric motor or an actuator, for example. Driving mechanism 130 is not limited to a configuration including the piezoelectric motor or the actuator, and may be configured to include, for example, a voice coil motor.

Each of first magnet 140 and second magnet 150 is attached to lens holder 120. Each of first magnetic sensor 160 and second magnetic sensor 170 is fixed on substrate 110. Each of first magnetic sensor 160 and second magnetic sensor 170 is mounted on a mounting surface 111 orthogonal or substantially orthogonal to the Z-axis direction. Mounting surface 111 is a main surface of substrate 110.

As shown in FIG. 1, first magnet 140 is located on the outer peripheral side with respect to lens holder 120. As shown in FIG. 2, first magnet 140 is located on one side in the Z-axis direction with respect to first magnetic sensor 160. First magnet 140 has a rectangular or substantially rectangular parallelepiped shape. As shown in FIG. 1, a polarizing direction of first magnet 140 is along the X-axis direction. A polarizing orientation 141 of first magnet 140 is toward the other side thereof in the X-axis direction. Specifically, one side of first magnet 140 in the X-axis direction is the S pole, and the other side of first magnet 140 in the X-axis direction is the N pole. First magnet 140 generates a first magnetic field.

As shown in FIG. 1, second magnet 150 is located on the outer peripheral side with respect to lens holder 120. Second magnet 150 is located opposite to first magnet 140 in a radial direction of lens holder 120. As shown in FIG. 2, second magnet 150 is located on one side in the Z-axis direction with respect to second magnetic sensor 170. Second magnet 150 has a rectangular or substantially rectangular parallelepiped shape. As shown in FIG. 1, a polarizing direction of second magnet 150 is along the Y-axis direction. A polarizing orientation 151 of second magnet 150 is toward the other side thereof in the Y-axis direction. Specifically, one side of 141 in the Y-axis direction is the S pole, and the other side of first magnet 140 in the Y-axis direction is the N pole. Second magnet 150 generates a second magnetic field.

In the present preferred embodiment, first magnet 140 and second magnet 150 are moved together with lens holder 120 in the Z-axis direction and the XY in-plane direction. That is, a relative position of first magnet 140 with respect to first magnetic sensor 160 can be changed in each of the X-axis direction, the Y-axis direction, and the Z-axis direction. A relative position of second magnet 150 with respect to second magnetic sensor 170 can be changed in each of the X-axis direction, the Y-axis direction, and the Z-axis direction.

First magnetic sensor 160 is disposed at a position not to overlap with first magnet 140 in the Z-axis direction when second magnet 150 and second magnetic sensor 170 are located at positions to overlap with each other in the Z-axis direction. When first magnet 140 and first magnetic sensor 160 are located at positions to overlap with each other in the Z-axis direction, second magnetic sensor 170 is located at a position not to overlap with second magnet 150 in the Z-axis direction.

First magnetic sensor 160 detects the first magnetic field applied from first magnet 140 relatively moved when lens holder 120 is moved. Second magnetic sensor 170 detects the second magnetic field applied from second magnet 150 relatively moved when lens holder 120 is moved.

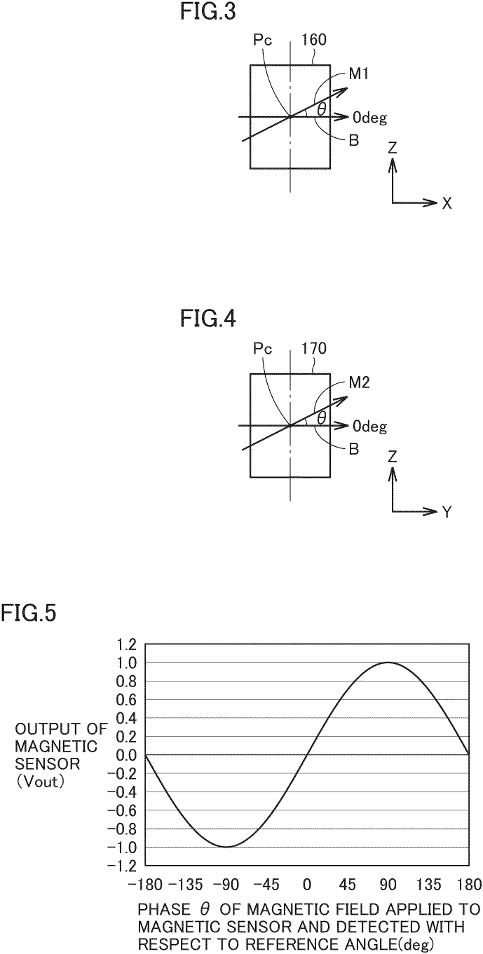

FIG. 3 is a plan view showing a phase of the first magnetic field with respect to a reference angle, the first magnetic field acting on a magnetization sensing surface of the first magnetic sensor included in the position detection device according to the present preferred embodiment. As shown in FIG. 3, the magnetization sensing surface of first magnetic sensor 160 is along each of the X-axis direction and the Z-axis direction. First magnetic sensor 160 detects a first magnetic field M1 applied from first magnet 140. When the relative position of first magnet 140 with respect to first magnetic sensor 160 is changed, a phase θ of first magnetic field M1 with respect to a reference angle B passing through a center Pc of first magnetic sensor 160 is displaced.

FIG. 4 is a plan view showing a phase of the first magnetic field with respect to a reference angle, the first magnetic field acting on a magnetization sensing surface of the second magnetic sensor included in the position detection device according to the present preferred embodiment. As shown in FIG. 4, the magnetization sensing surface of second magnetic sensor 170 is along each of the Y-axis direction and the Z-axis direction. Second magnetic sensor 170 detects a second magnetic field M2 applied from second magnet 150. When the relative position of second magnet 150 with respect to second magnetic sensor 170 is changed, a phase θ of second magnetic field M2 with respect to a reference angle B passing through a center Pc of second magnetic sensor 170 is displaced.

FIG. 5 is a graph showing a relationship between a phase of a magnetic field applied to a magnetic sensor with respect to a reference angle and an output of the magnetic sensor in the position detection device according to the present preferred embodiment. In FIG. 5, the vertical axis represents each of outputs (Vout) of first magnetic sensor 160 and second magnetic sensor 170, and the horizontal axis represents each of phases θ (deg) of magnetic fields M1, M2 with respect to the reference angles, magnetic fields M1, M2 being applied to first magnetic sensor 160 and second magnetic sensor 170. FIG. 5 shows a transition in the output (Vout) of each of first magnetic sensor 160 and second magnetic sensor 170 when magnetic fields M1, M2 each equal to or more than a saturation magnetic field are applied to magnetoresistance elements included in the magnetic sensors regardless of phases θ of magnetic fields M1, M2 with respect to reference angles B.

As shown in FIG. 5, a relationship of Vout = sinθ is satisfied between each of the outputs (Vout) of first magnetic sensor 160 and second magnetic sensor 170 and each of phases θ of magnetic fields M1, M2 with respect to reference angles B, magnetic fields M1, M2 being applied to first magnetic sensor 160 and second magnetic sensor 170.

In a range in which the outputs (Vout) of first magnetic sensor 160 and second magnetic sensor 170 have linearity with respect to phases θ of magnetic fields M1, M2 with respect to reference angles B, phases θ of magnetic fields M1, M2 with respect to reference angles B can be detected by first magnetic sensor 160 and second magnetic sensor 170. That is, phases θ of magnetic fields M1, M2 with respect to reference angles B can be detected by first magnetic sensor 160 and second magnetic sensor 170 in a range of a substantially straight inclination portion other than a curved vertex portion in the sin curve.

On the other hand, when θ = about 90° or θ = about -90°, the outputs (Vout) of first magnetic sensor 160 and second magnetic sensor 170 do not have linearity with respect to phases θ of magnetic fields M1, M2 with respect to reference angles B, with the result that phases θ of magnetic fields M1, M2 with respect to reference angles B cannot be detected by first magnetic sensor 160 and second magnetic sensor 170.

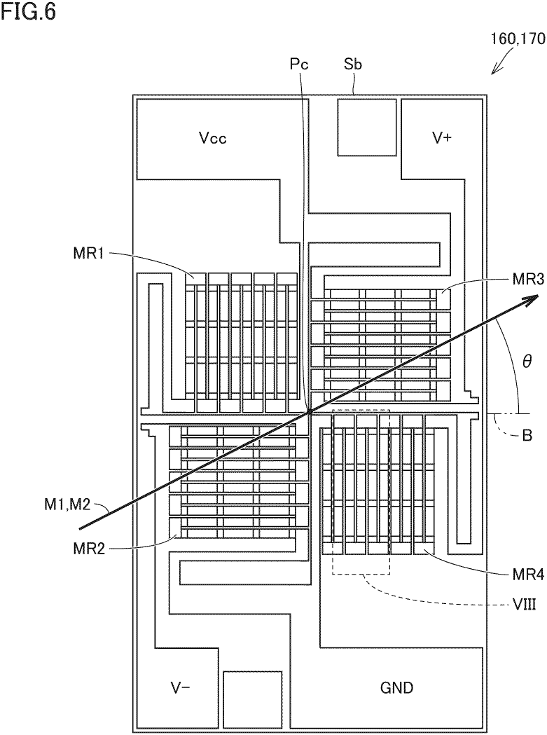

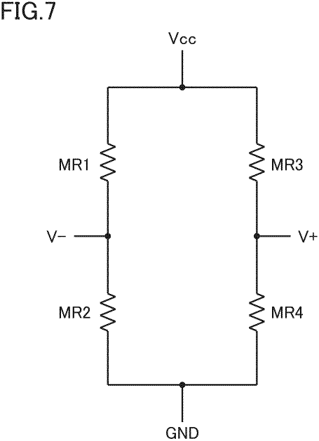

FIG. 6 is a diagram showing a configuration of each of the first magnetic sensor and the second magnetic sensor included in the position detection device according to the present preferred embodiment. FIG. 7 is a diagram showing a circuit configuration of each of the first magnetic sensor and the second magnetic sensor included in the position detection device according to the present preferred embodiment.

As shown in FIGS. 6 and 7, each of first magnetic sensor 160 and second magnetic sensor 170 includes a plurality of magnetoresistance elements that define a bridge circuit. In the present preferred embodiment, each of first magnetic sensor 160 and second magnetic sensor 170 includes, for example, a first magnetoresistance element MR1, a second magnetoresistance element MR2, a third magnetoresistance element MR3, and a fourth magnetoresistance element MR4.

Specifically, for example, as shown in FIG. 6, in each of first magnetic sensor 160 and second magnetic sensor 170, each of first magnetoresistance element MR1, second magnetoresistance element MR2, third magnetoresistance element MR3, and fourth magnetoresistance element MR4 is provided on an upper surface of a sensor substrate Sb. A power supply terminal Vcc, a ground terminal GND, a first output terminal V+, and a second output terminal V- are provided on sensor substrate Sb. First magnetic field M1 is applied to first magnetic sensor 160 in a direction along the magnetization sensing surface located on the upper surface of sensor substrate Sb. Second magnetic field M2 is applied to second magnetic sensor 170 in a direction along the magnetization sensing surface located on the upper surface of sensor substrate Sb.

First magnetoresistance element MR1, second magnetoresistance element MR2, third magnetoresistance element MR3, and fourth magnetoresistance element MR4 are electrically connected together to define, for example, a Wheatstone bridge circuit. Each of first magnetic sensor 160 and second magnetic sensor 170 may have, for example, a half bridge circuit including first magnetoresistance element MR1 and second magnetoresistance element MR2.

A group of first magnetoresistance element MR1 and second magnetoresistance element MR2 connected in series and a group of third magnetoresistance element MR3 and fourth magnetoresistance element MR4 connected in series are connected in parallel between power supply terminal Vcc and ground terminal GND. First output terminal V+ is connected to a connection point between first magnetoresistance element MR1 and second magnetoresistance element MR2. Second output terminal V- is connected to a connection point between third magnetoresistance element MR3 and fourth magnetoresistance element MR4.

Each of first magnetoresistance element MR1, second magnetoresistance element MR2, third magnetoresistance element MR3, and fourth magnetoresistance element MR4 is, for example, a TMR (Tunnel Magneto Resistance) element.

The outer shape of each of first magnetoresistance element MR1, second magnetoresistance element MR2, third magnetoresistance element MR3, and fourth magnetoresistance element MR4 is quadrangular or substantially quadrangular, for example. First magnetoresistance element MR1, second magnetoresistance element MR2, third magnetoresistance element MR3, and fourth magnetoresistance element MR4 have, for example, a square or substantially square shape. Center Pc of each of first magnetic sensor 160 and second magnetic sensor 170 is located at the center or approximate center of the square.

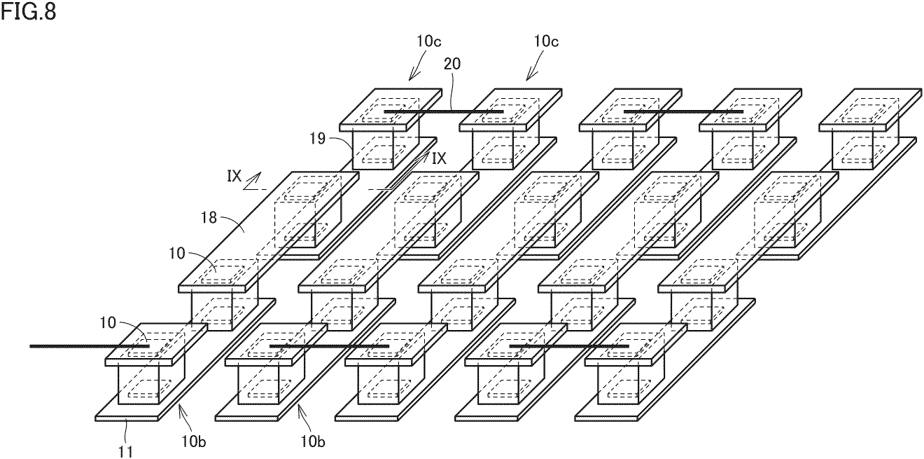

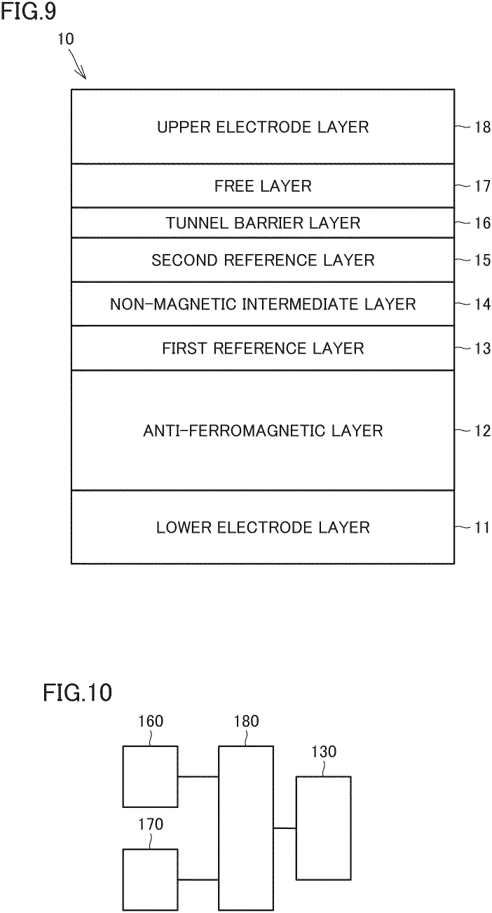

FIG. 8 is an enlarged perspective view of a portion VIII in FIG. 6. FIG. 9 is a cross sectional view when viewed in a direction of arrow of a line IX-IX in FIG. 8. As shown in FIG. 8, each of first magnetoresistance element MR1, second magnetoresistance element MR2, third magnetoresistance element MR3, and fourth magnetoresistance element MR4 is provided by connecting a plurality of TMR elements 10 in series. The plurality of TMR elements 10 are provided in a matrix.

Specifically, a multilayer element 10b includes the plurality of TMR elements 10 layered and connected in series. A plurality of such multilayer elements 10b connected together in series define an element array 10c. A plurality of such element arrays 10c are connected together by connecting ends of element arrays 10c to the other ends of element arrays 10c by leads 20. Thus, the plurality of TMR elements 10 are electrically connected in series in each of first magnetoresistance element MR1, second magnetoresistance element MR2, third magnetoresistance element MR3, and fourth magnetoresistance element MR4.

As shown in FIG. 8, an upper electrode layer 18 of a TMR element 10 on the lower side and a lower electrode layer 11 of a TMR element 10 on the upper side in multilayer element 10b are integrally provided as an intermediate electrode layer 19. That is, upper electrode layer 18 and lower electrode layer 11 in TMR elements 10 adjacent to each other in multilayer element 10b are integrally provided as intermediate electrode layer 19.

As shown in FIG. 9, each of TMR elements 10 of first magnetoresistance element MR1, second magnetoresistance element MR2, third magnetoresistance element MR3, and fourth magnetoresistance element MR4 has a layered structure including lower electrode layer 11, an anti-ferromagnetic layer 12, a first reference layer 13, a non-magnetic intermediate layer 14, a second reference layer 15, a tunnel barrier layer 16, a free layer 17, and upper electrode layer 18.

Lower electrode layer 11 includes, for example, a metal layer or metal compound layer including Ta and Cu. Anti-ferromagnetic layer 12 is provided on lower electrode layer 11, and includes, for example, a metal compound layer such as IrMn, PtMn, FeMn, NiMn, RuRhMn, or CrPtMn. First reference layer 13 is provided on anti-ferromagnetic layer 12, and includes, for example, a ferromagnetic layer such as CoFe.

Non-magnetic intermediate layer 14 is provided on first reference layer 13, and includes, for example, a layer of at least one metal selected from Ru, Cr, Rh, Ir, and Re, or a layer including an alloy of two or more of these metals. Second reference layer 15 is provided on non-magnetic intermediate layer 14, and includes, for example, a ferromagnetic layer such as CoFe or CoFeB.

Tunnel barrier layer 16 is provided on second reference layer 15 and includes, for example, a layer including an oxide containing at least one or two or more of Mg, Al, Ti, Zn, Hf, Ge, and Si, such as magnesium oxide. Free layer 17 is provided on tunnel barrier layer 16 and includes, for example, a layer including CoFeB, a layer including at least one metal of Co, Fe and Ni, or a layer including an alloy of two or more of these metals. Upper electrode layer 18 is provided on free layer 17, and includes, for example, a metal layer such as Ta, Ru, or Cu.

The magnetization direction of the pinned layer of each of first magnetoresistance element MR1 and fourth magnetoresistance element MR4 and the magnetization direction of the pinned layer of each of second magnetoresistance element MR2 and third magnetoresistance element MR3 are opposite to each other by about 180°.

Each of first magnetoresistance element MR1, second magnetoresistance element MR2, third magnetoresistance element MR3, and fourth magnetoresistance element MR4 may have a magnetoresistance element such as, for example, a GMR (Giant Magneto Resistance) element or an AMR (Anisotropic Magneto Resistance) element, instead of the TMR element.

FIG. 10 is a block diagram showing a configuration of connection between the position detection device according to the present preferred embodiment and the driving mechanism. As shown in FIG. 10, each of first magnetic sensor 160 and second magnetic sensor 170 is electrically connected to driving mechanism 130 via a controller 180. Each of output values of first magnetic sensor 160 and second magnetic sensor 170 is input to controller 180. Controller 180 controls an operation of driving mechanism 130 based on each of the output values from first magnetic sensor 160 and second magnetic sensor 170.

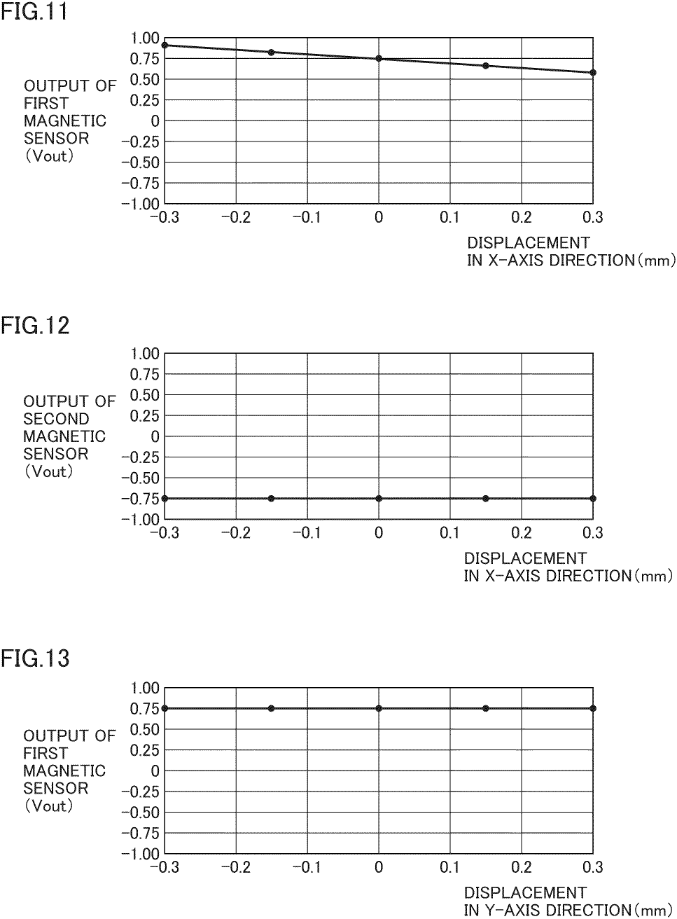

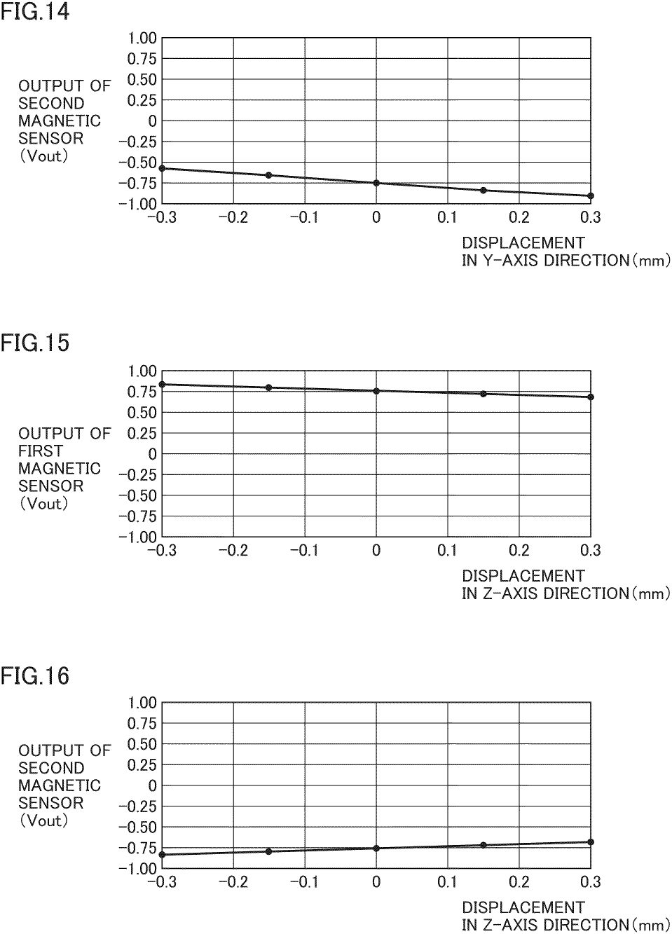

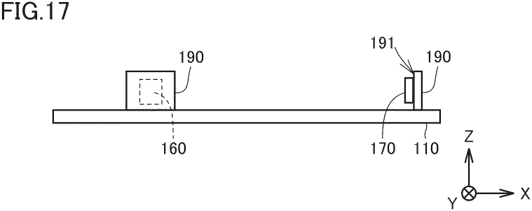

FIG. 11 is a graph showing a transition in output value of the first magnetic sensor due to displacement of the lens holder in the X-axis direction in the position detection device according to the present preferred embodiment. FIG. 12 is a graph showing a transition in output value of the second magnetic sensor due to the displacement of the lens holder in the X-axis direction in the position detection device according to the present preferred embodiment. FIG. 13 is a graph showing a transition in output value of the first magnetic sensor due to displacement of the lens holder in the Y-axis direction in the position detection device according to the present preferred embodiment. FIG. 14 is a graph showing a transition in output value of the second magnetic sensor due to the displacement of the lens holder in the Y-axis direction in the position detection device according to the present preferred embodiment. FIG. 15 is a graph showing a transition in output value of the first magnetic sensor due to displacement of the lens holder in the Z-axis direction in the position detection device according to the present preferred embodiment. FIG. 16 is a graph showing a transition in output value of the second magnetic sensor due to the displacement of the lens holder in the Z-axis direction in the position detection device according to the present preferred embodiment.

In FIG. 11, the horizontal axis represents the displacement (mm) of the lens holder in the X-axis direction, and the vertical axis represents the output value (Vout) of first magnetic sensor 160. In FIG. 12, the horizontal axis represents the displacement (mm) of the lens holder in the X-axis direction, and the vertical axis represents the output value (Vout) of second magnetic sensor 170. In FIG. 13, the horizontal axis represents the displacement (mm) of the lens holder in the Y-axis direction, and the vertical axis represents the output value (Vout) of first magnetic sensor 160. In FIG. 14, the horizontal axis represents the displacement (mm) of the lens holder in the Y-axis direction, and the vertical axis represents the output value (Vout) of second magnetic sensor 170. In FIG. 15, the horizontal axis represents the displacement (mm) of the lens holder in the Z-axis direction, and the vertical axis represents the output value (Vout) of first magnetic sensor 160. In FIG. 16, the horizontal axis represents the displacement (mm) of the lens holder in the Z-axis direction, and the vertical axis represents the output value (Vout) of second magnetic sensor 170.

As shown in FIGS. 11 and 12, when lens holder 120 is displaced to one side in the X-axis direction, the output value of first magnetic sensor 160 is decreased while having linearity, and the output value of second magnetic sensor 170 is substantially unchanged.

As shown in FIGS. 13 and 14, when lens holder 120 is displaced in one direction in the Y-axis direction, the output value of first magnetic sensor 160 is substantially unchanged, and the output value of second magnetic sensor 170 is decreased while having linearity.

As shown in FIGS. 15 and 16, when lens holder 120 is displaced to one side in the Z-axis direction, the output value of first magnetic sensor 160 is decreased while having linearity, and the output value of second magnetic sensor 170 is increased while having linearity.

Controller 180 detects the position of lens holder 120 in the X-axis direction based on a change in the output value of first magnetic sensor 160, detects the position of lens holder 120 in the Y-axis direction based on a change in the output value of second magnetic sensor 170, and detects the position of lens holder 120 in the Z-axis direction based on the changes in the output values of first magnetic sensor 160 and second magnetic sensor 170.

In the present preferred embodiment, controller 180 detects the position of lens holder 120 in the Z-axis direction based on a change in difference between the output value of first magnetic sensor 160 and the output value of second magnetic sensor 170. However, for example, controller 180 may detect the position of lens holder 120 in the Z-axis direction based on a change in sum of the output value of first magnetic sensor 160 and the output value of second magnetic sensor 170, or may detect the position of lens holder 120 in the Z-axis direction based on a change in only the output value of first magnetic sensor 160 or a change in only the output value of second magnetic sensor 170.

Controller 180 drives driving mechanism 130 based on the detected position of lens holder 120 in the Z-axis direction so as to move lens holder 120 in the optical axis direction, thus providing the autofocus function.

Next, controller 180 drives driving mechanism 130 based on the detected positions of lens holder 120 in the X-axis direction and the Y-axis direction so as to move lens holder 120 in the in-plane direction orthogonal or substantially orthogonal to the optical axis direction, thus providing the camera shake correction function.

In the position detection device according to the present preferred embodiment, the position of lens holder 120 in the X-axis direction is detected based on the change in the output value of first magnetic sensor 160, the position of lens holder 120 in the Y-axis direction is detected based on the change in the output value of second magnetic sensor 170, and the position of lens holder 120 in the Z-axis direction is detected based on the changes in the output values of first magnetic sensor 160 and second magnetic sensor 170. Thus, the positions in the X-axis direction, the Y-axis direction, and the Z-axis direction can be detected based on the output values of the two magnetic sensors.

Therefore, the size of lens driving device 100 and the number of components can be reduced, with the result that lens driving device 100 can be manufactured inexpensively.

In the present preferred embodiment, each of first magnetic sensor 160 and second magnetic sensor 170 includes the plurality of magnetoresistance elements that define a bridge circuit. Thus, an output value based on the direction of the magnetic field in the magnetization sensing surface can be obtained.

In the present preferred embodiment, each of first magnetic sensor 160 and second magnetic sensor 170 is mounted on mounting surface 111 orthogonal or substantially orthogonal to the Z-axis direction. Thus, each of first magnetic sensor 160 and second magnetic sensor 170 can be directly mounted on the main surface of substrate 110, which facilitates mounting of each of first magnetic sensor 160 and second magnetic sensor 170.

The manner of mounting of each of first magnetic sensor 160 and second magnetic sensor 170 is not limited to the above. FIG. 17 is a side view showing a manner of mounting of a first magnetic sensor and a second magnetic sensor in a position detection device according to a modification of aa preferred embodiment of the present invention.

As shown in FIG. 17, in the position detection device according to the modification of a preferred embodiment of the present invention, each of first magnetic sensor 160 and second magnetic sensor 170 is mounted on a mounting surface 191 parallel or substantially parallel to the Z-axis direction. In this modification, a mounting substrate 190 is mounted on substrate 110. Mounting surface 191 is a main surface of the mounting substrate. According to this configuration, each of first magnetic sensor 160 and second magnetic sensor 170 can be mounted on mounting substrate 190 in the same or substantially the same manner as a general chip component.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A position detection device comprising:
a lens holder holding a lens having an optical axis direction and being movable in the optical axis direction and an in-plane direction orthogonal or substantially orthogonal to the optical axis direction;
a first magnet attached to the lens holder to generate a first magnetic field;
a second magnet attached to the lens holder to generate a second magnetic field;
a first magnetic sensor that is fixed to detect the first magnetic field applied from the first magnet moved relatively when the lens holder is moved; and
a second magnetic sensor that is fixed to detect the second magnetic field applied from the second magnet moved relatively when the lens holder is moved; wherein
a polarizing direction of the first magnet is along a first direction orthogonal or substantially orthogonal to the optical axis direction;
a polarizing direction of the second magnet is along a second direction orthogonal or substantially orthogonal to each of the optical axis direction and the first direction;
a magnetization sensing surface of the first magnetic sensor extends along each of a third direction and the first direction, the third direction being parallel or substantially parallel to the optical axis direction;
a magnetization sensing surface of the second magnetic sensor extends along each of the third direction and the second direction;
the position detection device is operable to detect a position of the lens holder in the first direction based on a change in an output value of the first magnetic sensor;
the position detection device is operable to detect a position of the lens holder in the second direction based on a change in an output value of the second magnetic sensor; and
the position detection device is operable to detect a position of the lens holder in the third direction based on the changes in the output values of the first magnetic sensor and the second magnetic sensor.

2. The position detection device according to claim 1, wherein each of the first magnetic sensor and the second magnetic sensor includes a plurality of magnetoresistance elements defining a bridge circuit.

3. The position detection device according to claim 1, wherein each of the first magnetic sensor and the second magnetic sensor is mounted on a mounting surface orthogonal or substantially orthogonal to the third direction.

4. The position detection device according to claim 1, wherein each of the first magnetic sensor and the second magnetic sensor is mounted on a mounting surface parallel or substantially parallel to the third direction.

5. The position detection device according to claim 1, wherein the lens holder has a cylindrical or substantially cylindrical shape.

6. The position detection device according to claim 1, wherein the lens holder is mounted on a substrate with a driving mechanism interposed therebetween.

7. The position detection device according to claim 6, wherein the driving mechanism is structured to provide an autofocus function.

8. The position detection device according to claim 6, wherein the driving mechanism is structured to provide a cameral shape correction function.

9. The position detection device according to claim 6, wherein the driving mechanism includes a piezoelectric motor or an actuator.

10. The position detection device according to claim 1, wherein each of the first magnetic sensor and the second magnetic sensor includes a first magnetoresistance element, a second magnetoresistance element, a third magnetoresistance element, and a fourth magnetoresistance element.

11. The position detection device according to claim 10, wherein the first magnetoresistance element, the second magnetoresistance element, the third magnetoresistance element, and the fourth magnetoresistance element are electrically connected to define a Wheatstone bridge circuit.

12. The position detection device according to claim 10, wherein the first magnetoresistance element, the second magnetoresistance element, the third magnetoresistance element, and the fourth magnetoresistance element are connected in parallel between a power supply terminal and a ground terminal.

13. The position detection device according to claim 10, wherein each of the first magnetoresistance element, the second magnetoresistance element, the third magnetoresistance element, and the fourth magnetoresistance element is a Tunnel Magneto Resistance element.

14. The position detection device according to claim 10, wherein an outer shape of each of the first magnetoresistance element, the second magnetoresistance element, the third magnetoresistance element, and the fourth magnetoresistance element is quadrangular or substantially quadrangular.

15. The position detection device according to claim 10, wherein each of the first magnetoresistance element, the second magnetoresistance element, the third magnetoresistance element, and the fourth magnetoresistance element includes a plurality of Tunnel Magneto Resistance elements connected to each other in series.

16. The position detection device according to claim 15, wherein each of the plurality of Tunnel Magneto Resistance elements has a layered structure including a lower electrode layer, an anti-ferromagnetic layer, a first reference layer, a non-magnetic intermediate layer, a second reference layer, a tunnel barrier layer, a free layer, and upper electrode layer.

17. The position detection device according to claim 16, wherein the lower electrode layer includes a metal layer or metal compound layer including Ta and Cu.

18. The position detection device according to claim 16, wherein the anti-ferromagnetic layer includes at least one of IrMn, PtMn, FeMn, NiMn, RuRhMn, or CrPtMn.

19. The position detection device according to claim 16, wherein the first reference layer includes CoFe.

20. The position detection device according to claim 1, wherein the non-magnetic intermediate layer includes at least one of Ru, Cr, Rh, Ir, or Re, or an alloy including two or more of Ru, Cr, Rh, Ir, or Re.
